(19) United States
(12) Patent Application Publication
(10) Pub. No.: US 2025/0150216 A1
(43) Pub. Date: May 8, 2025

(54) CAPABILITIES FOR PHYSICAL SIDELINK FEEDBACK CHANNEL TRANSMISSION

(71) Applicant: QUALCOMM Incorporated, San Diego, CA (US)

(72) Inventors: Chih-Hao LIU, San Diego, CA (US); Jae Ho RYU, San Diego, CA (US); Giovanni CHISCI, San Diego, CA (US); Xiaoxia ZHANG, San Diego, CA (US)

(21) Appl. No.: 18/800,999

(22) Filed: Aug. 12, 2024

Related U.S. Application Data
(60) Provisional application No. 63/595,698, filed on Nov. 2, 2023.

(51) Int. Cl. H04L 1/1829; H04L 1/1812

(52) U.S. Cl. CPC H04L 1/1861; H04L 1/1812

(57) ABSTRACT

Various aspects of the present disclosure generally relate to wireless communication. In some aspects, a user equipment (UE) may transmit capability information indicating at least one of: a number of resource block (RB) sets that can be occupied by physical sidelink feedback channel (PSFCH) communications of the UE, or a maximum number of PSFCH communications supported by the UE, wherein the maximum number of PSFCH communications is associated with a configured number of PSFCH-carrying RBs. The UE may transmit or receive PSFCH feedback in accordance with at least one of the configured number of PSFCH-carrying RBs or the number of RB sets. Numerous other aspects are described.

### CROSS-REFERENCE TO RELATED APPLICATION

This Patent application claims priority to U.S. Provisional Patent Application No. 63/595,698, filed on Nov. 2, 2023, entitled “CAPABILITIES FOR PHYSICAL SIDELINK FEEDBACK CHANNEL TRANSMISSION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods for capabilities for physical sidelink feedback channel transmission.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, a method of wireless communication performed by a user equipment (UE) includes transmitting capability information indicating at least one of: a number of resource block (RB) sets that can be occupied by physical sidelink feedback channel (PSFCH) communications of the UE, or a maximum number of PSFCH communications supported by the UE, wherein the maximum number of PSFCH communications is associated with a configured number of PSFCH-carrying RBs; and transmitting or receiving PSFCH feedback in accordance with at least one of the configured number of PSFCH-carrying RBs or the number of RB sets.

In some aspects, an apparatus configured for wireless communications includes one or more memories comprising processor-executable instructions; and one or more processors configured to execute the processor-executable instructions and cause the apparatus to transmit capability information indicating at least one of: a number of RB sets that can be occupied by PSFCH communications of the UE, or a maximum number of PSFCH communications supported by the UE, wherein the maximum number of PSFCH communications is associated with a configured number of PSFCH-carrying RBs; and transmit or receive PSFCH feedback in accordance with at least one of the configured number of PSFCH-carrying RBs or the number of RB sets.

In some aspects, a non-transitory computer-readable medium storing a set of instructions for wireless communication includes one or more instructions that, when executed by one or more processors of a UE, cause the UE to: transmit capability information indicating at least one of: a number of RB sets that can be occupied by PSFCH communications of the UE, or a maximum number of PSFCH communications supported by the UE, wherein the maximum number of PSFCH communications is associated with a configured number of PSFCH-carrying RBs; and transmit or receive PSFCH feedback in accordance with at least one of the configured number of PSFCH-carrying RBs or the number of RB sets.

In some aspects, an apparatus for wireless communication includes means for transmitting capability information indicating at least one of: a number of RB sets that can be occupied by PSFCH communications of the apparatus, or a maximum number of PSFCH communications supported by the apparatus, wherein the maximum number of PSFCH communications is associated with a configured number of PSFCH-carrying RBs; and means for transmitting or receiving PSFCH feedback in accordance with at least one of the configured number of PSFCH-carrying RBs or the number of RB sets.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example UE in a wireless network in accordance with the present disclosure.

FIG. 3 is a diagram illustrating an example disaggregated base station architecture in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIG. 6 is a diagram illustrating an example of physical sidelink feedback channel (PSFCH) transmission with a common interlace, in accordance with the present disclosure.

FIG. 7 is a diagram illustrating an example of signaling of capabilities for PSFCH transmission, in accordance with the present disclosure.

FIG. 8 is a diagram illustrating an example process performed, for example, at a UE or an apparatus of a UE, in accordance with the present disclosure.

FIG. 9 is a diagram illustrating an example of an implementation of code and circuitry for a communications device, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

User equipments (UEs) may communicate with one another directly without such communications traveling via an intermediary such as a radio access network (RAN) or a base station. Such communications are referred to herein as sidelink communications. UEs may perform sidelink communications via various physical channels. For example, a UE may transmit a sidelink communication via a physical sidelink control channel (PSCCH) and/or a physical sidelink shared channel (PSSCH). Some UEs may be capable of providing feedback, such as hybrid automatic repeat request (HARQ) feedback, indicating whether a sidelink communication was received. A UE may transmit such feedback via a physical sidelink feedback channel (PSFCH). The PSFCH may also be used for a conflict indication, which may be used to indicate that the UE has received resource reservations that conflict with one another. A conflict indication, or an instance of HARQ feedback (e.g., a HARQ acknowledgment (ACK) or negative ACK (NACK) corresponding to a given sidelink communication) may be referred to as a PSFCH communication. One or more PSFCH communications may be collectively referred to herein as “PSFCH feedback.”

UEs may communicate on spectrum that utilizes a channel access mechanism, such as an unlicensed channel. For example, prior to gaining access to and/or transmitting over a channel such as an unlicensed channel, a transmitting device may perform a listen-before-talk (LBT) procedure to contend for access to the unlicensed channel. The LBT procedure may generally include a clear channel assessment (CCA) procedure that is performed in order to determine whether the channel is available (e.g., unoccupied by other transmitters). In particular, the CCA procedure may include detecting an energy level on the channel and determining whether the energy level satisfies (e.g., is less than or equal to) a threshold, sometimes referred to as an energy detection threshold and/or the like. When the energy level satisfies (e.g., does not equal or exceed) the threshold, the CCA procedure is deemed to be successful, and the transmitting device may gain access to the channel for a duration that may be referred to as a channel occupancy time (COT) during which the transmitting device can perform transmissions without performing additional LBT operations. When the energy level does not satisfy the threshold, the CCA procedure is unsuccessful and contention to access the channel may be deemed unsuccessful.

In some deployments, a channel access mechanism may specify an occupied channel bandwidth (OCB) requirement, which indicates a minimum bandwidth that a given transmitter must occupy so that other transmitters are aware of the given transmitter's presence. In some examples, waveforms (such as PSFCH waveforms for transmission of PSFCH feedback) may be configured to satisfy the OCB requirement, even if the amount of data to be transmitted via the waveform is insufficient to fully occupy a number of resource blocks (RBs) spanning the full OCB. For example, a waveform may implement an interlace, which may provide for a number of RBs of an RB set to be occupied such that the number of RBs span the OCB. The number of RBs can be occupied by “dummy” transmissions (e.g., transmissions carrying no data), repetitions of data (such as PSFCH feedback), or a combination thereof.

In some aspects, a UE may transmit or receive multiple PSFCH communications in a single time resource, such as a single symbol or a single slot. For example, a single receiving UE may transmit HARQ feedback to multiple transmitting UEs. As another example, a single transmitting UE may receive HARQ feedback from multiple receiving UEs (such as in response to a groupcast communication transmitted by the single transmitting UE to the multiple receiving UEs). Different UEs may have different capabilities with regard to the number of PSFCH communications that each UE can transmit or receive in a given time resource. Thus, a UE may report a capability for a maximum number of PSFCH communications supported by the UE in a slot, such as via a parameter M for PSFCH transmissions by the UE and/or a parameter N for PSFCH receptions by the UE.

As mentioned, a PSFCH may be transmitted using a PSFCH waveform. In some examples, the PSFCH waveform may include an interlace and a number of PSFCH-carrying RBs. A PSFCH-carrying RB is an RB that is used for (e.g., dedicated for) transmission of PSFCH feedback. A PSFCH-carrying RB may include an ACK/NACK-carrying RB, in some examples. The number of PSFCH-carrying RBs can include one or more RBs. For example, in some aspects, the number of PSFCH-carrying RBs may be configured for a UE (e.g., via a parameter K3). Example values of the number of PSFCH-carrying RBs include 1, 2, 5, 10, and 11. For values of K3 above 1, PSFCH feedback on a PSFCH-carrying RB may be repeated across K3 RBs using frequency-domain repetition. For example, K3 RBs carrying a given PSFCH may be transmitted on a same interlace. In some examples, RBs for a different PSFCH can be transmitted on a different interlace. The PSFCH waveform may be transmitted on an RB set, which may include multiple RBs that span a channel bandwidth (e.g., a 20 MHz channel bandwidth, a channel bandwidth of unlicensed spectrum).

As mentioned, a UE may have a capability for a number of RBs that can be occupied (e.g., concurrently) by PSFCH communications of the UE, and may report this capability via a parameter M and/or N. A UE may also be configured with a number of PSFCH-carrying RBs. However, as the number of PSFCH-carrying RBs increases, the complexity of PSFCH transmission or reception also increases. Therefore, a UE may be capable of transmitting or receiving a number of PSFCH communications for a first number of PSFCH-carrying RBs, but may be unable or not configured to transmit or receive the same number of PSFCH communications for a second number of PSFCH-carrying RBs. In such cases, the UE may fail to transmit or receive PSFCH communications for higher numbers of PSFCH-carrying RBs, or may be configured with an unduly conservative number of PSFCH-carrying RBs or concurrent PSFCH communications, thereby reducing efficiency of sidelink communication.

Furthermore, in some scenarios, a UE may be configured to communicate (e.g., transmit or receive PSFCH feedback) on multiple RB sets. The multiple RB sets may include contiguous RB sets (which may be adjacent to one another in frequency, such as separated by only a guard band), or may include non-contiguous RB sets (which may be separated from one another by a frequency gap greater than a guard band, such as by one or more RBs, channels, or channel bandwidths). However, as the number of RB sets increases, complexity of PSFCH transmission or reception also increases. For example, a larger number of RB sets may lead to a larger number of common interlaces to be transmitted. Furthermore, non-contiguous RB set transmission or reception may be associated with more stringent peak-to-average-power ratio (PAPR) thresholds than contiguous RB set transmission. Therefore, a UE may be capable of transmitting or receiving PSFCH feedback for a first number of RB sets and not for a second number of RB sets. Additionally, or alternatively, a UE may be capable of transmitting or receiving PSFCH feedback for a number of RB sets if the RB sets are contiguous, but not if the RB sets are non-contiguous. In such cases, the UE may fail to transmit or receive PSFCH communications for higher numbers of RB sets or non-contiguous RB sets, or may be configured with an unduly conservative number of RB sets (or an unduly conservative configuration of contiguous or non-contiguous RB sets), thereby reducing efficiency of sidelink communication. Furthermore, in some aspects, the number of PSFCH communications may be on a number of RB sets that exceeds a capability of the UE. In this scenario, indiscriminately dropping PSFCH communications may lead to suboptimal outcomes, such as missing high-priority communications.

Aspects of the present disclosure relate generally to PSFCH transmission. Some aspects more specifically relate to PSFCH capability signaling. In some aspects, a UE may transmit capability information indicating a number of RB sets that can be occupied by PSFCH communications of the UE. Additionally, or alternatively, the UE may transmit capability information indicating a maximum number of PSFCH communications (e.g., M and/or N), associated with a configured number of PSFCH-carrying RBs (e.g., K3), supported by the UE. The UE may transmit or receive feedback in accordance with at least one of the configured number of PSFCH-carrying RBs or the number of RB sets. In some aspects, the capability information may indicate a maximum number of PSFCH communications that is specific to a number of PSFCH-carrying RBs. In some aspects, the capability information may indicate a number of contiguous RB sets that multiple PSFCH communications can occupy. Additionally, or alternatively, the capability information may indicate a number of non-contiguous RB sets that multiple PSFCH communications can occupy. In some aspects, the UE may prioritize dropping of PSFCH communications when PSFCH communications are to be transmitted or received on a number of RB sets that exceeds the UE's capability. For example, the UE may drop one or more PSFCH communications according to priorities associated with the one or more PSFCH communications, or according to whether a PSFCH communication is HARQ feedback or a conflict indicator. “Dropping a PSFCH communication” may include skipping transmission of the PSFCH communication, skipping reception of the PSFCH communication, ceasing monitoring of a PSFCH resource configured for the PSFCH communication, or the like.

Aspects of the present disclosure may be used to realize one or more of the following possible advantages. In some aspects, by transmitting the capability information indicating the number of RB sets that can be occupied by PSFCH communications of the UE, or the maximum number of PSFCH communications (e.g., M and/or N), associated with a configured number of PSFCH-carrying RBs (e.g., K3), the UE enables configuration of multiple RB sets and/or multiple PSFCH-carrying RBs without exceeding the capabilities of the UE, thereby improving efficiency of sidelink communication and utilization of sidelink resources. In some aspects, by indicating a maximum number of PSFCH communications that is specific to a number of PSFCH-carrying RBs, the UE may enable configuration of different numbers of PSFCH-carrying RBs without exceeding capabilities of the UE and without configuring overly conservative numbers of PSFCH communications or PSFCH-carrying RBs. By indicating a number of contiguous or non-contiguous RB sets that multiple PSFCH communications can occupy, the UE may enable configuration of contiguous RB sets and/or non-contiguous RB sets to support PSFCH transmission, which improves flexibility of implementation of sidelink communications. By prioritizing dropping of PSFCH communications when PSFCH communications are to be transmitted or received on a number of RB sets that exceeds the UE's capability (such as according to priorities associated with the one or more PSFCH communications, or according to whether a PSFCH communication is HARQ feedback or a conflict indicator), the UE improves reliability of high-priority communications, reduces delay associated with missed feedback, and improves efficiency of network communication.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

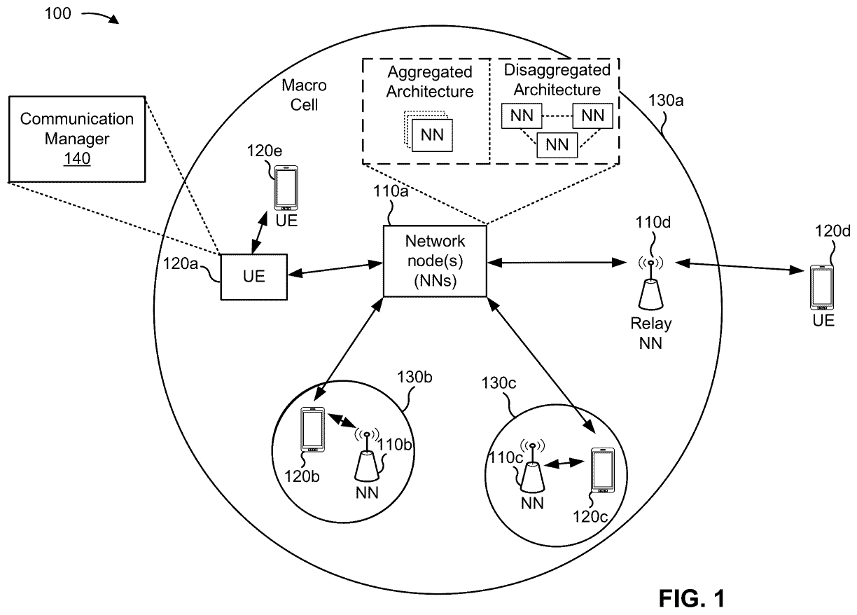

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular radio access technology (RAT) (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHZ through 24.25 GHZ), FR4a or FR4-1 (52.6 GHz through 71 GHZ), FR4 (52.6 GHz through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long-Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a non-terrestrial network (NTN) network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of ultra-reliable low-latency communication (URLLC), enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some radio access technologies (RATs) may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may transmit capability information indicating at least one of: a number of RB sets that can be occupied by PSFCH communications of the UE, or a maximum number of PSFCH communications supported by the UE, wherein the maximum number of PSFCH communications is associated with a configured number of PSFCH-carrying RBs; and transmit or receive PSFCH feedback in accordance with at least one of the configured number of PSFCH-carrying RBs or the number of RB sets. Additionally, or alternatively, the communication manager 140 may perform one or more other operations described herein.

As indicated above, FIG. 1 is provided as an example. Other examples may differ from what is described with regard to FIG. 1.

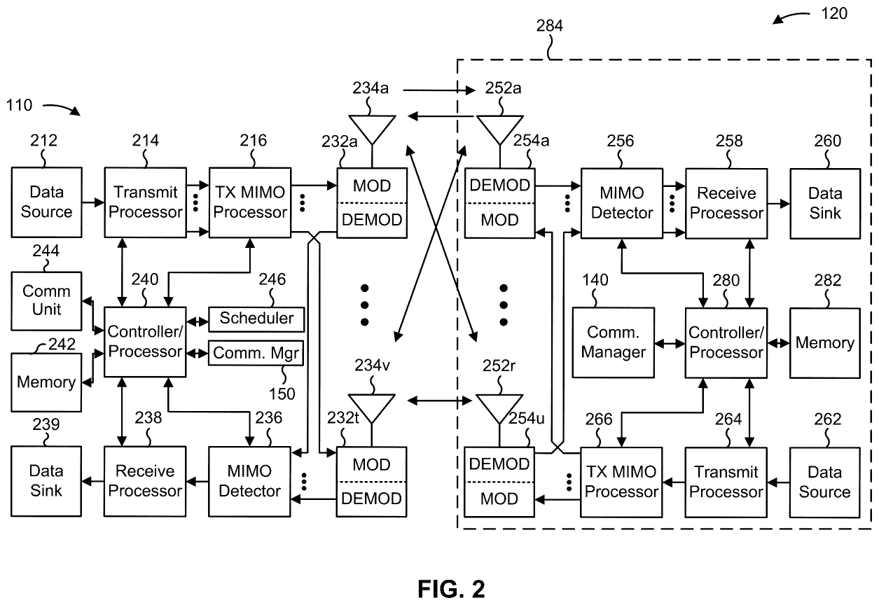

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, whereu≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

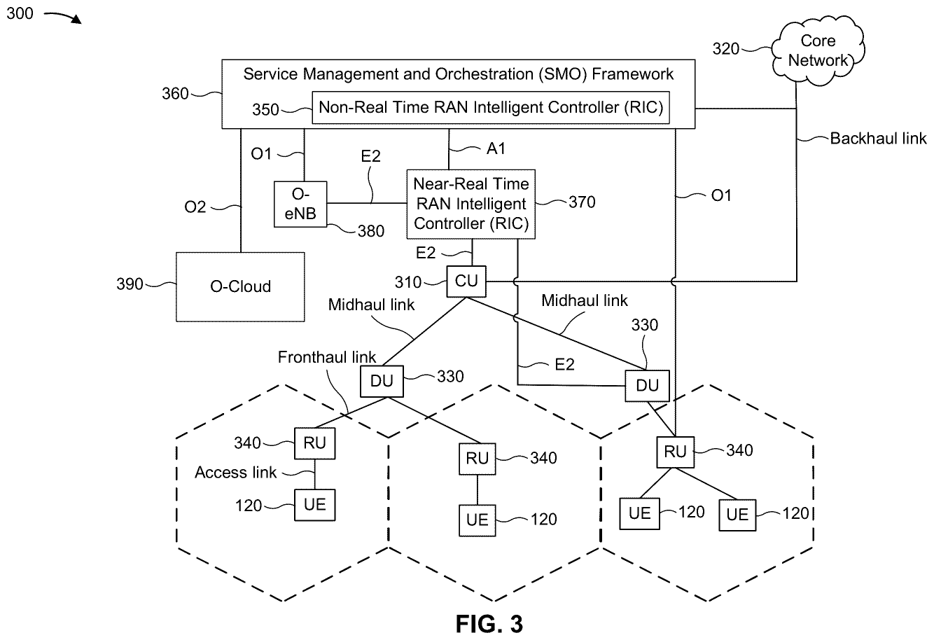

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, artificial intelligence and/or machine learning (AI/ML) workflows including model training and updates, and/or policy-based guidance of applications and/or features in the Near-RT RIC 370. The Non-RT RIC 350 may be coupled to or may communicate with (such as via an AI interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as AI interface policies).

As indicated above, FIG. 3 is provided as an example. Other examples may differ from what is described with regard to FIG. 3.

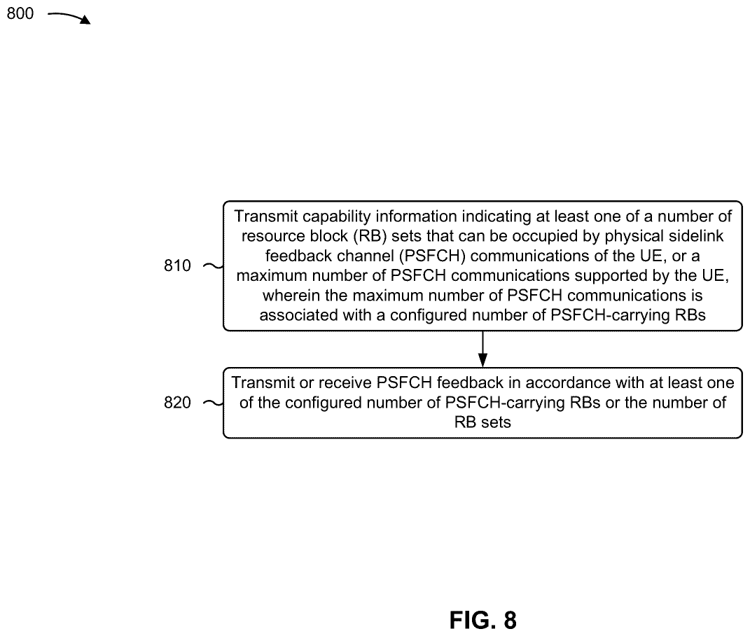

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with capability signaling, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 800 of FIG. 8, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8, or other processes as described herein. In some examples, executing instructions may include running the instructions, converting the instructions, compiling the instructions, and/or interpreting the instructions, among other examples.

In some aspects, the UE 120 includes means for transmitting capability information indicating at least one of: a number of RB sets that can be occupied by PSFCH communications of the UE 120, or a maximum number of PSFCH communications supported by the UE 120, wherein the maximum number of PSFCH communications is associated with a configured number of PSFCH-carrying RBs; and/or means for transmitting or receiving PSFCH feedback in accordance with at least one of the configured number of PSFCH-carrying RBs or the number of RB sets. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

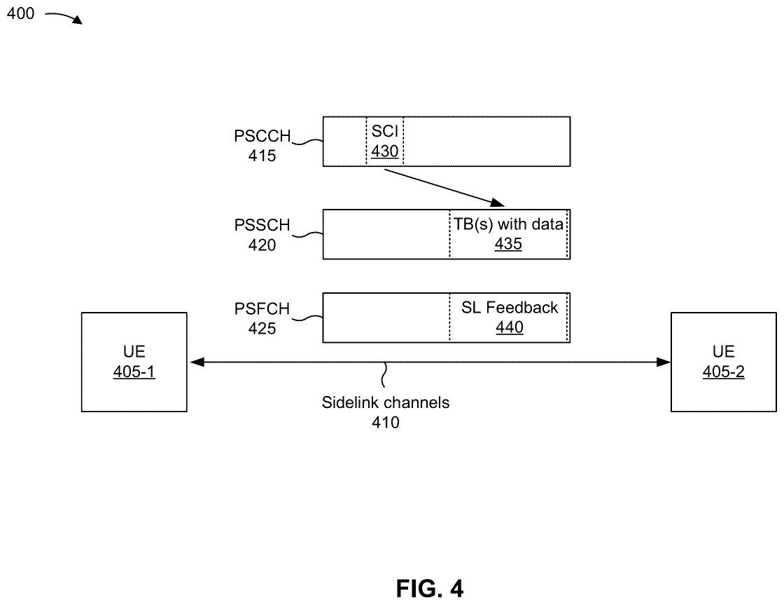

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QOS) priority value, a resource reservation period, a PSSCH demodulation reference signal (DMRS) pattern, an SCI format for the SCI-2, a beta offset for the SCI-2, a quantity of PSSCH DMRS ports, and/or an MCS. The SCI-2 may include information associated with data transmissions on the PSSCH 420, such as a hybrid automatic repeat request (HARQ) process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a network node 110 (e.g., a base station, a CU, or a DU). For example, the UE 405 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 405 may operate using a transmission mode (e.g., Mode 2) where resource selection and/or scheduling is performed by the UE 405 (e.g., rather than a network node 110). In some aspects, the UE 405 may perform resource selection and/or scheduling by sensing channel availability for transmissions. For example, the UE 405 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or an MCS to be used for the upcoming sidelink transmission. In some aspects, a UE 405 may generate a sidelink grant that indicates one or more parameters for SPS, such as a periodicity of a sidelink transmission. Additionally, or alternatively, the UE 405 may generate a sidelink grant for event-driven scheduling, such as for an on-demand sidelink message.

As indicated above, FIG. 4 is provided as an example. Other examples may differ from what is described with respect to FIG. 4.

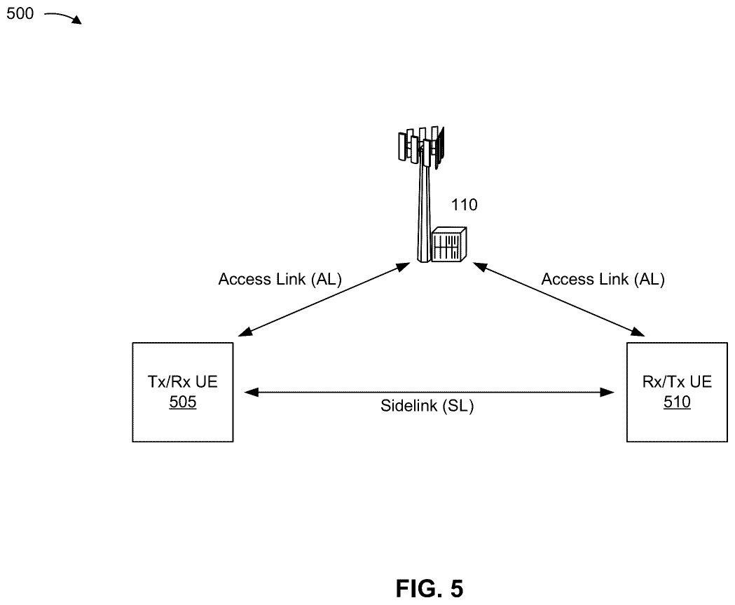

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a network node 110 may communicate with the Tx/Rx UE 505 (e.g., directly or via one or more network nodes), such as via a first access link. Additionally, or alternatively, in some sidelink modes, the network node 110 may communicate with the Rx/Tx UE 510 (e.g., directly or via one or more network nodes), such as via a first access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 5 is provided as an example. Other examples may differ from what is described with respect to FIG. 5.

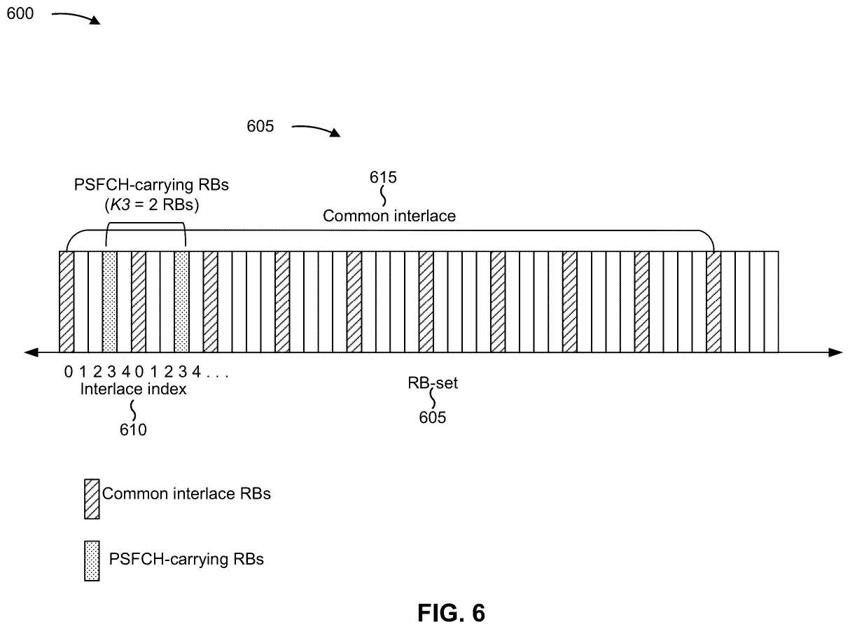

FIG. 6 is a diagram illustrating an example 600 of PSFCH transmission with a common interlace, in accordance with the present disclosure. In FIG. 6, the horizontal axis represents frequency. FIG. 6 shows an RB set 605. The RB set 605 may include a number of RBs, which may all occur in a same time resource (e.g., slot). For example, in FIG. 6, the RB set 605 may include 43 RBs. For example, a 20 MHz channel may include 55 RBs, which may include 6 RBs of guard band on each side of the RB set 605, leaving 43 RBs for the RB set 605. The RB set 605 may correspond to a channel bandwidth of a channel, such as a channel of a band with a decentralized channel access mechanism (e.g., an unlicensed band).

Interlace indexes are shown by reference number 610. In example 600, there are five interlace indexes (0, 1, 2, 3, and 4), meaning that five different communications can be multiplexed in the RB set 605, and meaning that RBs of a given interlace occur in every fifth RB position of the RB set 605. In this example, RBs of a common interlace (shown by reference number 615) are indicated by a diagonal fill. As shown, the RBs of the common interlace are positioned according to interlace index 0.

PSFCH feedback is shown by a dotted fill. PSFCH feedback may occur on PSFCH-carrying RBs. In example 600, the PSFCH feedback occurs on interlace index 3, meaning that PSFCH-carrying RBs are configured on RBs with interlace index 3. Furthermore, in example 600, a configured number of PSFCH-carrying RBs is “2” (i.e., K3=2). Thus, two instances of the PSFCH-carrying RBs occur in the RB set 605. In some aspects, a same PSFCH may be transmitted in each of the PSFCH-carrying RBs shown by the dotted fill. In some aspects, additional PSFCHs can be transmitted on interlace indexes other than interlace indexes 0 and 3, and each of these PSFCHs can be configured with a respective value of K3.

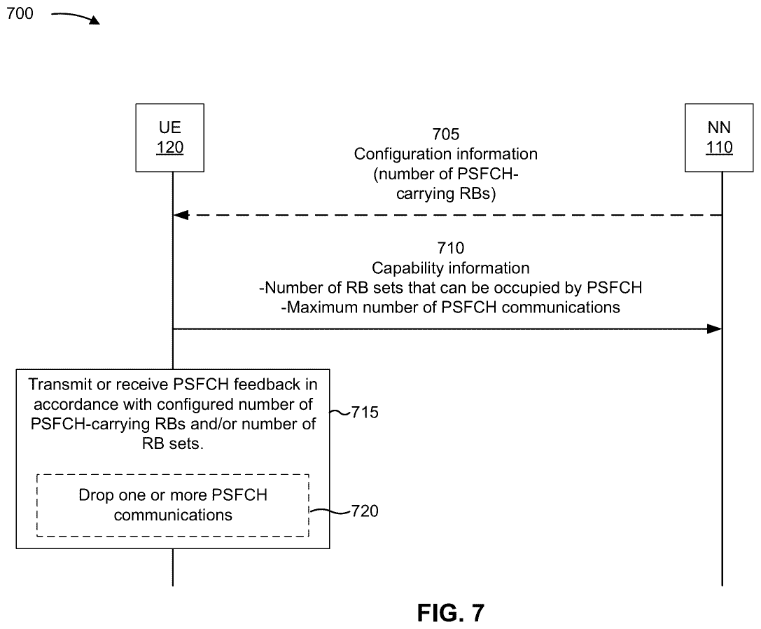

Some aspects described herein provide signaling of capability information indicating a number of RB sets 605 that can be occupied by PSFCH communications of the UE. Some aspects described herein provide signaling of capability information indicating a maximum number of PSFCH communications supported by the UE, wherein the maximum number of PSFCH communications is associated with a configured number of PSFCH-carrying RBs. These aspects are described in more detail in connection with FIG. 7.

As indicated above, FIG. 6 is provided as an example. Other examples may differ from what is described with regard to FIG. 6.

FIG. 7 is a diagram illustrating an example 700 of signaling of capabilities for PSFCH transmission, in accordance with the present disclosure. Example 700 includes a UE 120 and a network node 110. In some examples, the operations of example 700 may be performed between a first UE 120 and a second UE 120. For example, the first UE 120 may transmit capability information to the second UE 120 (e.g., in place of or in addition to the network node 110). As another example, the second UE 120 may provide configuration information to the first UE 120.

As shown by reference number 705, in some aspects, the network node 110 (or another UE) may transmit, and the UE 120 may receive, configuration information. In some aspects, the configuration information may include a configuration of a number of PSFCH-carrying RBs (e.g., a value of K3). Thus, the number of PSFCH-carrying RBs may be referred to as a configured number of PSFCH-carrying RBs. The configuration of the number of PSFCH-carrying RBs may indicate a number of RBs, in a given time resource (e.g., slot), that are usable for PSFCH feedback. An illustration of a number of 2 PSFCH-carrying RBs is provided in example 600 of FIG. 6. As mentioned elsewhere herein, PSFCH feedback can include one or more ACK/NACKs, one or more conflict indications, or a combination thereof. An ACK/NACK may indicate whether a given transmission was received. A conflict indication may indicate a conflict associated with a given resource, such as due to two SCIs (from two different UEs) each scheduling a communication on the given resource. PSFCH feedback may include one or more PSFCH communications, where a PSFCH communication is either an ACK/NACK or a conflict indication.

As shown by reference number 710, the UE 120 may transmit, and the network node 110 (or another UE) may receive, capability information. For example, the UE 120 may transmit the capability information after receiving the configuration information shown by reference number 705. As another example, the UE 120 may transmit the capability information before receiving the configuration information shown by reference number 705 or in the absence of the configuration information shown by reference number 705. In some aspects, the capability information may indicate a number of RB sets (e.g., RB set 605) that can be occupied by PSFCH communications. Additionally, or alternatively, the capability information may indicate a maximum number of PSFCH communications, associated with a number of PSFCH-carrying RBs, supported by the UE 120. Each of these is described in turn below.

In some aspects, the capability information may indicate a number of RB sets that can be occupied by PSFCH communications. For example, the capability information may indicate a number of contiguous or non-contiguous RB sets that multiple PSFCH communications can occupy. An RB set may be occupied by PSFCH communications if at least one PSFCH communication is transmitted or received by the UE 120 in that RB set. Additionally, or alternatively, an RB set may be occupied by PSFCH communications if at least a threshold number of PSFCH communications are transmitted or received by the UE 120 in that RB set. For example, the RB set 605 is occupied by PSFCH communications. In some aspects, the capability information may indicate a number of contiguous RB sets that can be occupied by PSFCH communications. Additionally, or alternatively, the capability information may indicate a number of non-contiguous RB sets that can be occupied by PSFCH communications. For example, the number of non-contiguous RB sets may be different than the number of contiguous RB sets. “Contiguous” and “non-contiguous,” in the context of RB sets, are defined elsewhere herein.

In some aspects, the capability information may indicate a maximum number of PSFCH communications supported by the UE 120. For example, the capability information may indicate the maximum number of PSFCH communications for one or more numbers of PSFCH-carrying RBs. In some aspects, the capability information may indicate the maximum number of PSFCH communications for a configured number of PSFCH-carrying RBs, such as the number of PSFCH-carrying RBs configured at reference number 705. Additionally, or alternatively, the capability information may indicate the maximum number of PSFCH communications for multiple numbers of PSFCH-carrying RBs. For example, the capability information may indicate a first maximum number of PSFCH communications for a first number of PSFCH-carrying RBs (e.g., for K3=1), a second maximum number of PSFCH communications for a second number of PSFCH-carrying RBs (e.g., for K3=2), and so on for any quantity of numbers of PSFCH-carrying RBs (e.g., for K3=1, 2, 5, 10, 11, and/or another value). In some aspects, the maximum number of PSFCH communications may indicate a maximum number of transmissions on PSFCH resources that the UE 120 can transmit in a slot (e.g., M). Additionally, or alternatively, the maximum number of PSFCH communications May indicate a maximum number of receptions on PSFCH resources that the UE 120 can receive in a slot (e.g., N).

In some aspects, the maximum number of PSFCH communications may be selected from a set of selectable values for the maximum number of PSFCH communications. In some aspects, the set of selectable values (sometimes referred to as a set of maximum numbers of PSFCH communications) may correspond to a number of PSFCH-carrying RBs (e.g., K3). For example, when reporting capability information indicating a maximum number of PSFCH communications for a particular value of K3, the UE 120 may select the maximum number of PSFCH communications (e.g., M and/or N) from a set of selectable values corresponding to the particular value of K3. In some aspects, the sets of selectable values may be different for different values of K3. For example, a first value of K3 may be associated with a first set of selectable values (e.g., M and/or N), a second value of K3 may be associated with a second set of selectable values, and so on. Defining different sets of selectable values (e.g., different pluralities of maximum numbers of PSFCH communications) for different values of K3 may improve flexibility of capability signaling. Defining different sets of selectable values may also enable a UE 120 to maintain approximately the same level of complexity (regarding PSFCH transmission or reception) across different values of K3. For example, a larger value of K3 may generally be associated with lower maximum numbers of PSFCH communications than a smaller value of K3, which may be beneficial since the larger value of K3 may involve more complexity for PSFCH transmission or reception than the smaller value of K3.

As mere examples, when K3 is equal to 1, the UE 120 may select M from {4, 8, 16} and N from {5, 15, 25, 32, 35, 45, 50, 64}. When K3 is equal to 2, the UE 120 may select M from {2, 4, 8} and N from {2, 7, 12, 16, 17, 22, 25, 32}. When K3 is equal to 5, the UE 120 may select M from {1, 2, 3} and N from {1,3,5,6,7,9,10,13}. When K3 is equal to 10, the UE 120 may select M from {1, 2} and N from {1, 2, 3, 4, 5, 6}. Thus, the total number of RBs for multiple PSFCH transmissions is held approximately constant across different values of K3, thereby providing an approximately equal level of hardware complexity across the values of K3.

As shown by reference number 715, the UE 120 may transmit or receive PSFCH feedback (e.g., one or more PSFCH communications) in accordance with the configured number of PSFCH-carrying RBs and/or the number of RB sets that can be occupied by PSFCH communications. For example, the UE 120 may transmit or receive PSFCH feedback on, at most, the number of PSFCH-carrying RBs, and the PSFCH feedback may include at most the maximum number of PSFCH communications indicated by the UE 120 at reference number 710. As another example, the UE 120 may transmit or receive PSFCH feedback on, at most, a number of RB sets as indicated by the UE 120 at reference number 710.

As shown by reference number 720, in some aspects, transmitting or receiving the PSFCH feedback may include dropping one or more PSFCH communications of the PSFCH feedback. For example, the UE 120 may drop one or more ACK/NACKs, one or more conflict indications, or a combination thereof. In some aspects, the UE 120 may drop the one or more PSFCH communications in accordance with the maximum number of PSFCH communications or the number of RB sets, as indicated in the capability information shown by reference number 710. For example, the UE 120 may drop a sufficient number of PSFCH communications so that an actually transmitted or received number of PSFCH communications is lower than or equal to the maximum number of PSFCH communications, and/or so that the transmitted or received PSFCH communications occur on at most the number of RB sets.

In some aspects, the UE 120 may select the one or more PSFCH communications to be dropped. In some aspects, the UE 120 may drop the one or more PSFCH communications according to one or more priorities associated with the one or more PSFCH communications. More particularly, the UE 120 may drop one or more PSFCH communications relating to (e.g., indicating feedback for) information (such as a PSSCH) having lower than a threshold priority value or a lowest priority value. As another example of dropping according to priorities, the UE 120 may first drop conflict indications, and may next (second) drop ACK/NACKs. Thus, the UE 120 may prioritize PSFCH transmission or reception according to a HARQ-ACK first and conflict indication second priority, and according to ascending order of priority value for information carried by the PSFCH.

As indicated above, FIG. 7 is provided as an example. Other examples may differ from what is described with regard to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with capability reporting for PSFCHs.

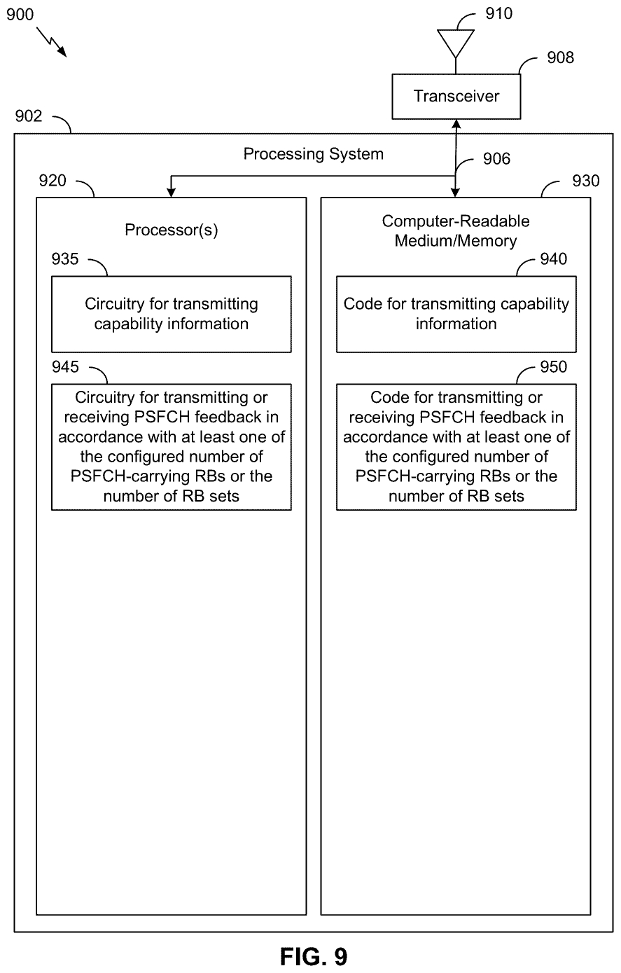

As shown in FIG. 8, in some aspects, process 800 may include transmitting capability information indicating at least one of a number of RB sets that can be occupied by PSFCH communications of the UE, or a maximum number of PSFCH communications supported by the UE associated with a configured number of PSFCH-carrying RBs (block 810). For example, the UE (e.g., using transceiver 908 and/or antenna 910, depicted in FIG. 9) may transmit capability information indicating at least one of a number RB sets that can be occupied by PSFCH communications of the UE, or a maximum number of PSFCH communications supported by the UE. The maximum number of PSFCH communications may be associated with a configured number of PSFCH-carrying RBs, as described above with respect to reference number 710 of FIG. 7.

As further shown in FIG. 8, in some aspects, process 800 may include transmitting or receiving PSFCH feedback in accordance with at least one of the configured number of PSFCH-carrying RBs or the number of RB sets (block 820). For example, the UE (e.g., using transceiver 908 and/or antenna 910, depicted in FIG. 9) may transmit or receive PSFCH feedback in accordance with at least one of the configured number of PSFCH-carrying RBs or the number of RB sets, as described above with regard to reference number 715 of FIG. 7.

Process 800 may include additional aspects, such as any single aspect or any combination of aspects described below and/or in connection with one or more other processes described elsewhere herein.

In a first aspect, process 800 includes receiving a configuration of the number of PSFCH-carrying RBs, wherein the capability information indicates the maximum number of PSFCH communications supported by the UE.

In a second aspect, alone or in combination with the first aspect, the number of PSFCH-carrying RBs indicates a number of RBs, in a given time resource, that are usable for the PSFCH feedback.

In a third aspect, alone or in combination with one or more of the first and second aspects, the PSFCH feedback includes a hybrid automatic repeat request feedback or a conflict indication.

In a fourth aspect, alone or in combination with one or more of the first through third aspects, the capability information indicates a plurality of maximum numbers of PSFCH communications supported by the UE, where each maximum number of PSFCH communications, of the plurality of maximum numbers of PSFCH communications, corresponds to a different number of PSFCH-carrying RBs of a plurality of numbers of PSFCH-carrying RBs.

In a fifth aspect, alone or in combination with one or more of the first through fourth aspects, the plurality of maximum numbers of PSFCH communications includes a first maximum number of PSFCH communications and a second maximum number of PSFCH communications, wherein the first maximum number of PSFCH communications corresponds to a first number of PSFCH-carrying RBs of the plurality of numbers of PSFCH-carrying RBs, wherein the second maximum number of PSFCH communications corresponds to a second number of ACK/NACK-carrying RBs of the plurality of numbers of PSFCH-carrying RBs, wherein the first maximum number of PSFCH communications is higher than the second maximum number of PSFCH communications, and wherein the first number of PSFCH-carrying RBs is lower than the second number of PSFCH-carrying RBs.

In a sixth aspect, alone or in combination with one or more of the first through fifth aspects, the maximum number of PSFCH communications supported by the UE is selected from a set of maximum numbers of PSFCH communications, wherein the set of maximum numbers of PSFCH communications corresponds to the number of PSFCH-carrying RBs.

In a seventh aspect, alone or in combination with one or more of the first through sixth aspects, transmitting or receiving the PSFCH feedback in accordance with at least one of the configuration or the number of RB sets comprises transmitting or receiving the PSFCH feedback that includes, at most, the maximum number of PSFCH communications.

In an eighth aspect, alone or in combination with one or more of the first through seventh aspects, the capability information indicates the number of RB sets.

In a ninth aspect, alone or in combination with one or more of the first through eighth aspects, the number of RB sets is a number of contiguous RB sets.

In a tenth aspect, alone or in combination with one or more of the first through ninth aspects, the number of RB sets is a number of non-contiguous RB sets.

In an eleventh aspect, alone or in combination with one or more of the first through tenth aspects, the number of RB sets indicates a number of contiguous or non-contiguous RB sets that multiple PSFCH communications can occupy.

In a twelfth aspect, alone or in combination with one or more of the first through eleventh aspects, transmitting or receiving the PSFCH feedback in accordance with at least one of the configured number of PSFCH-carrying RBs or the number of RB sets comprises dropping one or more PSFCH communications of the PSFCH feedback in accordance with at least one of the maximum number of PSFCH communications or the number of RB sets.

In a thirteenth aspect, alone or in combination with one or more of the first through twelfth aspects, dropping the one or more PSFCH communications comprises dropping the one or more PSFCH communications according to one or more priorities associated with the one or more PSFCH communications.

In a fourteenth aspect, alone or in combination with one or more of the first through thirteenth aspects, dropping the one or more PSFCH communications further dropping the one or more PSFCH communications according to at least one of whether the one or more PSFCH communications carry a hybrid automatic repeat request (HARQ) acknowledgment or a conflict indication, or a priority value for information carried by the one or more PSFCH communications.

In a fifteenth aspect, alone or in combination with one or more of the first through fourteenth aspects, dropping the one or more PSFCH communications comprises dropping the one or more PSFCH communications in accordance with the number of RB sets being exceeded.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example of an implementation of code and circuitry for a communications device 900, in accordance with the present disclosure. The communications device 900 may be a UE, or a UE may include the communications device 900.

The communications device 900 includes a processing system 902 coupled to a transceiver 908 (e.g., a transmitter and/or a receiver, and which may include a single transceivers or multiple transceivers which may perform different operations described as being performed by the transceiver 908). The transceiver 908 is configured to transmit and receive signals for the communications device 900 via an antenna 910, such as the various signals as described herein. The processing system 902 may be configured to perform processing functions for the communications device 900, including processing signals received and/or to be transmitted by the communications device 900.

The processing system 902 includes one or more processors 920. In various aspects, the one or more processors 920 may include one or more of receive processor 258, transmit processor 264, TX MIMO processor 266, and/or controller/processor 280, as described with respect to FIG. 2. The one or more processors 920 are coupled to a computer-readable medium/memory 930 via a bus 906. In various aspects, the computer-readable medium/memory 930 may include one or more memories such as memory 282, as described with respect to FIG. 2. In certain aspects, the computer-readable medium/memory 930 is configured to store instructions (e.g., computer-executable code, processor-executable code) that when executed by the one or more processors 920, cause the one or more processors 920 to perform the process 800 described with respect to FIG. 8, or any aspect related to it. Note that reference to a processor performing a function of communications device 900 may include one or more processors performing that function of communications device 900. Note also that reference to one or more processors performing multiple functions may include a first processor performing a first function of the multiple functions and a second processor performing a second function of the multiple functions.

As shown in FIG. 9, the communications device 900 may include circuitry for transmitting capability information (circuitry 935). As shown in FIG. 9, the communications device 900 may include, stored in computer-readable medium/memory 930, code for transmitting capability information indicating at least one of (code 940).

As shown in FIG. 9, the communications device 900 may include circuitry for transmitting or receiving PSFCH feedback in accordance with at least one of the configured number of PSFCH-carrying RBs or the number of RB sets (circuitry 945).

As shown in FIG. 9, the communications device 900 may include, stored in computer-readable medium/memory 930, code for transmitting or receiving PSFCH feedback in accordance with at least one of the configured number of PSFCH-carrying RBs or the number of RB sets (code 950).

Various components of the communications device 900 may provide means for performing the process 800 described with respect to FIG. 8, or any aspect related to it. For example, means for transmitting, sending, or outputting for transmission may include the modem(s) 254 and/or antenna(s) 252 of the UE 120 and/or transceiver 908 and antenna 910 of the communications device 900 in FIG. 9. Means for receiving or obtaining may include the modem(s) 254 and/or antenna(s) 252 of the UE 120 and/or transceiver 908 and antenna 910 of the communications device 900 in FIG. 9.

FIG. 9 is provided as an example. Other examples may differ from what is described in connection with FIG. 9.

The following provides an overview of some Aspects of the present disclosure:
Aspect 1: A method of wireless communication performed by a user equipment (UE), comprising: transmitting capability information indicating at least one of: a number of resource block (RB) sets that can be occupied by physical sidelink feedback channel (PSFCH) communications of the UE, or a maximum number of PSFCH communications supported by the UE, wherein the maximum number of PSFCH communications is associated with a configured number of PSFCH-carrying RBs; and transmitting or receiving PSFCH feedback in accordance with at least one of the configured number of PSFCH-carrying RBs or the number of RB sets.
Aspect 2: The method of Aspect 1, further comprising receiving a configuration of the number of PSFCH-carrying RBs, wherein the capability information indicates the maximum number of PSFCH communications supported by the UE.
Aspect 3: The method of Aspect 2, wherein the number of PSFCH-carrying RBs indicates a number of RBs, in a given time resource, that are usable for the PSFCH feedback.
Aspect 4: The method of Aspect 3, wherein the PSFCH feedback includes a hybrid automatic repeat request feedback or a conflict indication.
Aspect 5: The method of Aspect 2, wherein the capability information indicates a plurality of maximum numbers of PSFCH communications supported by the UE, where each maximum number of PSFCH communications, of the plurality of maximum numbers of PSFCH communications, corresponds to a different number of PSFCH-carrying RBs of a plurality of numbers of PSFCH-carrying RBs.
Aspect 6: The method of Aspect 5, wherein the plurality of maximum numbers of PSFCH communications includes a first maximum number of PSFCH communications and a second maximum number of PSFCH communications, wherein the first maximum number of PSFCH communications corresponds to a first number of PSFCH-carrying RBs of the plurality of numbers of PSFCH-carrying RBs, wherein the second maximum number of PSFCH communications corresponds to a second number of ACK/NACK-carrying RBs of the plurality of numbers of PSFCH-carrying RBs, wherein the first maximum number of PSFCH communications is higher than the second maximum number of PSFCH communications, and wherein the first number of PSFCH-carrying RBs is lower than the second number of PSFCH-carrying RBs.
Aspect 7: The method of Aspect 2, wherein the maximum number of PSFCH communications supported by the UE is selected from a set of maximum numbers of PSFCH communications, wherein the set of maximum numbers of PSFCH communications corresponds to the number of PSFCH-carrying RBs.
Aspect 8: The method of Aspect 2, wherein transmitting or receiving the PSFCH feedback in accordance with at least one of the configuration or the number of RB sets comprises transmitting or receiving the PSFCH feedback that includes, at most, the maximum number of PSFCH communications.
Aspect 9: The method of any of Aspects 1-8, wherein the capability information indicates the number of RB sets.
Aspect 10: The method of Aspect 9, wherein the number of RB sets is a number of contiguous RB sets.
Aspect 11: The method of Aspect 9, wherein the number of RB sets is a number of non-contiguous RB sets.
Aspect 12: The method of Aspect 9, wherein the number of RB sets indicates a number of contiguous or non-contiguous RB sets that multiple PSFCH communications can occupy.
Aspect 13: The method of Aspect 9, wherein transmitting or receiving the PSFCH feedback in accordance with at least one of the configured number of PSFCH-carrying RBs or the number of RB sets comprises dropping one or more PSFCH communications of the PSFCH feedback in accordance with at least one of the maximum number of PSFCH communications or the number of RB sets.
Aspect 14: The method of Aspect 13, wherein dropping the one or more PSFCH communications comprises dropping the one or more PSFCH communications according to one or more priorities associated with the one or more PSFCH communications.
Aspect 15: The method of Aspect 13, wherein dropping the one or more PSFCH communications further dropping the one or more PSFCH communications according to at least one of: whether the one or more PSFCH communications carry a hybrid automatic repeat request (HARQ) acknowledgment or a conflict indication, or a priority value for information carried by the one or more PSFCH communications.
Aspect 16: The method of Aspect 13, wherein dropping the one or more PSFCH communications comprises dropping the one or more PSFCH communications in accordance with the number of RB sets being exceeded.
Aspect 17: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-16.
Aspect 18: An apparatus for wireless communication at a device, the apparatus comprising one or more memories and one or more processors coupled to the one or more memories, the one or more processors configured to cause the device to perform the method of one or more of Aspects 1-16.
Aspect 19: An apparatus for wireless communication, the apparatus comprising at least one means for performing the method of one or more of Aspects 1-16.
Aspect 20: A non-transitory computer-readable medium storing code for wireless communication, the code comprising instructions executable by one or more processors to perform the method of one or more of Aspects 1-16.
Aspect 21: A non-transitory computer-readable medium storing a set of instructions for wireless communication, the set of instructions comprising one or more instructions that, when executed by one or more processors of a device, cause the device to perform the method of one or more of Aspects 1-16.
Aspect 22: A device for wireless communication, the device comprising a processing system that includes one or more processors and one or more memories coupled with the one or more processors, the processing system configured to cause the device to perform the method of one or more of Aspects 1-16.
Aspect 23: An apparatus for wireless communication at a device, the apparatus comprising one or more memories and one or more processors coupled to the one or more memories, the one or more processors individually or collectively configured to cause the device to perform the method of one or more of Aspects 1-16.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus configured for wireless communications, comprising:
one or more memories comprising processor-executable instructions; and
one or more processors configured to execute the processor-executable instructions and cause the apparatus to:
transmit capability information indicating at least one of:
a) a number of resource block (RB) sets that can be occupied by physical sidelink feedback channel (PSFCH) communications of the apparatus, or
b) a maximum number of PSFCH communications supported by the apparatus, wherein the maximum number of PSFCH communications is associated with a configured number of PSFCH-carrying RBs; and
transmit or receive PSFCH feedback in accordance with at least one of the configured number of PSFCH-carrying RBs or the number of RB sets.

2. The apparatus of claim 1, wherein the one or more processors are configured to cause the apparatus to receive a configuration of the number of PSFCH-carrying RBs, wherein the capability information indicates the maximum number of PSFCH communications supported by the apparatus.

3. The apparatus of claim 2, wherein the number of PSFCH-carrying RBs indicates a number of RBs, in a given time resource, that are usable for the PSFCH feedback.

4. The apparatus of claim 3, wherein the PSFCH feedback includes a hybrid automatic repeat request feedback or a conflict indication.

5. The apparatus of claim 2, wherein the maximum number of PSFCH communications supported by the apparatus is selected from a set of maximum numbers of PSFCH communications, wherein the set of maximum numbers of PSFCH communications corresponds to the number of PSFCH-carrying RBs.

6. The apparatus of claim 2, wherein the one or more processors, to cause the apparatus to transmit or receive the PSFCH feedback in accordance with at least one of the configuration or the number of RB sets, are configured to cause the apparatus to transmit or receive the PSFCH feedback that includes, at most, the maximum number of PSFCH communications.

7. The apparatus of claim 1, wherein the capability information indicates a plurality of maximum numbers of PSFCH communications supported by the apparatus, where each maximum number of PSFCH communications, of the plurality of maximum numbers of PSFCH communications, corresponds to a different number of PSFCH-carrying RBs of a plurality of numbers of PSFCH-carrying RBs.

8. The apparatus of claim 7, wherein the plurality of maximum numbers of PSFCH communications includes a first maximum number of PSFCH communications and a second maximum number of PSFCH communications, wherein the first maximum number of PSFCH communications corresponds to a first number of PSFCH-carrying RBs of the plurality of numbers of PSFCH-carrying RBs, wherein the second maximum number of PSFCH communications corresponds to a second number of ACK/NACK-carrying RBs of the plurality of numbers of PSFCH-carrying RBs, wherein the first maximum number of PSFCH communications is higher than the second maximum number of PSFCH communications, and wherein the first number of PSFCH-carrying RBs is lower than the second number of PSFCH-carrying RBs.

9. The apparatus of claim 1, wherein the capability information indicates the number of RB sets.

10. The apparatus of claim 9, wherein the number of RB sets is a number of contiguous RB sets.

11. The apparatus of claim 9, wherein the number of RB sets is a number of non-contiguous RB sets.

12. The apparatus of claim 9, wherein the number of RB sets indicates a number of contiguous or non-contiguous RB sets that multiple PSFCH communications can occupy.

13. The apparatus of claim 9, wherein the one or more processors, to cause the apparatus to transmit or receive the PSFCH feedback in accordance with at least one of the configured number of PSFCH-carrying RBs or the number of RB sets, are configured to cause the apparatus to drop one or more PSFCH communications of the PSFCH feedback in accordance with at least one of the maximum number of PSFCH communications or the number of RB sets.

14. The apparatus of claim 13, wherein the one or more processors, to cause the apparatus to drop the one or more PSFCH communications, are configured to cause the apparatus to drop the one or more PSFCH communications according to one or more priorities associated with the one or more PSFCH communications.

15. The apparatus of claim 13, wherein dropping the one or more PSFCH communications further dropping the one or more PSFCH communications according to at least one of:
whether the one or more PSFCH communications carry a hybrid automatic repeat request (HARQ) acknowledgment or a conflict indication, or
a priority value for information carried by the one or more PSFCH communications.

16. The apparatus of claim 13, wherein the one or more processors, to cause the apparatus to drop the one or more PSFCH communications, are configured to cause the apparatus to drop the one or more PSFCH communications in accordance with the number of RB sets being exceeded.

17. A method of wireless communication performed by a user equipment (UE), comprising:
transmitting capability information indicating at least one of:
a) a number of resource block (RB) sets that can be occupied by physical sidelink feedback channel (PSFCH) communications of the UE, or
b) a maximum number of PSFCH communications supported by the UE, wherein the maximum number of PSFCH communications is associated with a configured number of PSFCH-carrying RBs; and
transmitting or receiving PSFCH feedback in accordance with at least one of the configured number of PSFCH-carrying RBs or the number of RB sets.

18. The method of claim 17, further comprising:
receiving a configuration of the number of PSFCH-carrying RBs, wherein the capability information indicates the maximum number of PSFCH communications supported by the UE.

19. The method of claim 17, wherein the capability information indicates a plurality of maximum numbers of PSFCH communications supported by the UE, where each maximum number of PSFCH communications, of the plurality of maximum numbers of PSFCH communications, corresponds to a different number of PSFCH-carrying RBs of a plurality of numbers of PSFCH-carrying RBs.

20. A non-transitory computer-readable medium storing a set of instructions for wireless communication, the set of instructions comprising:
one or more instructions that, when executed by one or more processors of a user equipment (UE), cause the UE to:
transmit capability information indicating at least one of:
a number of resource block (RB) sets that can be occupied by physical sidelink feedback channel (PSFCH) communications of the UE, or
a maximum number of PSFCH communications supported by the UE, wherein the maximum number of PSFCH communications is associated with a configured number of PSFCH-carrying RBs; and
transmit or receive PSFCH feedback in accordance with at least one of the configured number of PSFCH-carrying RBs or the number of RB sets.
